(19) United States
(12) Patent Application Publication
(10) Pub. No.: US 2008/0241789 A1
(43) Pub. Date: Oct. 2, 2008

(54) One-Part Or Two-Part Dental Implant System

(76) Inventor: Soenke Mundorf, Hamburg (DE)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 11/816,816

(22) PCT Filed: Feb. 22, 2006
(86) PCT No.: PCT/EP2006/001599

§ 371 Date: Apr. 10, 2008

(30) Foreign Application Priority Data
Feb. 22, 2005 (DE) 10 2005 008 273.4

(51) Int. Cl. A61C 8/00; A61C 3/02

(52) U.S. Cl. 433/173; 433/165

(57) ABSTRACT

The invention concerns a dental implant comprising an intraosseal anchor portion anchorable in the jawbone with an external face for anchoring in the jawbone and a tooth abutment portion fastenable to the intraosseal anchor portion, to which a crown can be attached. Such dental implants suffer from the disadvantage that they do not provide an optimum treatment result in terms of the position of the transitions between the individual implant portions. The invention remedies that disadvantage insofar as the intraosseal anchor portion is in the form of an intratissue anchor portion and the intratissue anchor portion and optionally the tooth abutment portion is to be adapted to the individual gingival configuration by preparation by the dentist.

The invention concerns a dental implant comprising an intraosseal anchor portion anchorable in the jawbone with an external face for anchoring in the jawbone, and a tooth abutment portion fastenable to said intraosseal anchor portion, a crown being attachable to the tooth abutment portion. The invention can optionally be in the form of a dental implant comprising an intraosseal anchor portion anchorable in the jawbone with a first face for anchoring in the jawbone and a second face for fixing a crown.

Dental implants of the above-indicated kind and are used in dental therapy in order to completely replace one or more diseased or missing teeth. Those dental implants can be used in particular in the cosmetically relevant region, that is to say in the visible front and side tooth region, but they are also suitable for aesthetically demanding treatments in the less visible molar region. Dental implants of the above-indicated kind are also used as a holding device for removable dentures. Finally those dental implants also in part serve the cosmetic purpose of replacing teeth which have an adverse effect on aesthetic appearance.

For implantation of the dental implants in a first step an intraosseal anchor portion is primarily anchored in the jawbone. To achieve that primary anchorage effect the most generally accepted procedure is for the intraosseal anchor portion to be provided with a male screwthread which is screwed into the bone. The intraosseal anchor portion which is typically made from titanium materials is screwed into the bone to such an extent that it is disposed flush with the surface of the bone and consequently is no longer visible. No further processing of the intraosseal anchor portion is possible or required by virtue of the intraosseal anchor portion being completely sunk into the bone.

A second step involves fixing to the intraosseal anchor portion a tooth abutment portion to which a crown or a removable dental prosthesis can be attached. The tooth abutment portion is provided in the form of a straight or angled abutment. The tooth abutment portion is usually fixed to the intraosseal anchor portion by means of a screw which is to be screwed in the intraosseal anchor portion and which is passed through an opening in the tooth abutment portion and the head of which is received in counterpart holding relationship in the tooth abutment portion.

A third step involves fixing to the tooth abutment portion a crown which is modeled in geometry and color on the originally existing tooth or a tooth which is usually present at the location being treated, or a removable dental prosthesis.

Dental implants of the above-indicated kind are available for example under the name FRIALIT® from FRIADENT GmbH or under the name NOBELDIREC™ and NOBELPERFEC™ from Nobel Biocare AB, Sweden, the latter are described in U.S. Pat. No. 6,174,167, U.S. Pat. No. 6,283,754 and WO 2004/103203.

A serious disadvantage of the known systems is the optical appearance of the implanted dental implant. The join between the intraosseal anchor portion and the tooth abutment portion is usually produced by means of a screwthread in known implants, and that screwthread requires the use of materials of high tensile strength to achieve the required strength for the overall implant. A procedure which has therefore been successfully adopted involves producing the intraosseal anchor portion and the tooth abutment portion from titanium or a titanium alloy. That material restriction represents a problem as the dark-gray titanium material is admittedly covered by the crown which is usually matched to the color of the tooth, but in many cases the gum experiences some post-operative recession. Sometimes the implant cannot be ideally placed because of various factors. Those two phenomena result in a dark edge between the gum and the tooth, which adversely affects the aesthetic appearance and which is caused by the titanium material being exposed. Accordingly, with such a post-operative occurrence, even in the case of the two-part dental implants which are designed for the cosmetic region, the situation involves the aesthetic disadvantages which are already known from the dental implants for the region which is not visible.

In addition material restriction is a problem even with ideal implant placement and ideal post-operative healing as the titanium material can show through the bone and the gum and can thus massively disrupt the “red appearance”.

Known dental implants also suffer from the disadvantage that in many cases a microgap is formed subgingivally in the transition between the intraosseal anchor portion and the tooth abutment portion, which serves as a reservoir for germs. It is known that such germ reservoirs entail multiple problems, in particular gum-jawbone diseases (periimplantitis or parodontitis) and diseases of the surrounding teeth.

Another kind of implant which is suitable for the non-visible region, that is to say the region of the molars, dispenses with completely sinking the intraosseal anchor portion into the bone. With those dental implants the intraosseal anchor portion and the tooth abutment portion are designed in such a way that the intraosseal anchor portion projects out of the bone and the gum. The intraosseal anchor portion of those implants does not permit and does require any preparatory post-treatment by the dentist. Adaptation to the individual configuration of the gum is neither possible nor is it required for the desired end result, on the intraosseal anchor portion.

Those implants admittedly do not necessitate any additional treatment effort on the intraosseal anchor portion and can therefore be used in the non-visible region with reasonable treatment complication and expenditure, but they are not suitable for the cosmetically visible region as the intraosseal anchor portion is not concealed and consequently there is a dark edge between the crown and the gum, which seriously interferes with the aesthetic aspect.

A further disadvantage of all known dental implants is the considerable extent of the instruments involved and the implant portions, as is required for the prosthetic treatment. Known dental implants usually involve special instruments for adaptation of the dental prosthesis to the anatomical circumstances of the respective patient, in a technical laboratory context, as well as specific instruments with which the dentist prepares and executes anchorage in the jawbone and with which the dentist orients the individual parts of the implant system in the mouth of the patient, fixes them and puts them into shape.

Finally, a further problem of the known dental implants is that an increasing number of patients have a highly sensitive or allergic reaction to metallic materials such as titanium, inter alia caused by the spread of pieces of metallic jewelry which are implanted through the skin. Those patients can suffer from rejection reactions in respect of metallic implants, which give rise to serious problems in the post-treatment, which can lead to the need to remove the implant. In addition immunological problems due to metal ions and corrosion problems due to local galvanic elements are discussed.

Besides the above-described, so-called “two-part” implants which actually generally have more than two parts, so-called “one-part” implants are also known, in which an intraosseal anchor portion is so adapted that a crown or a removable dental prosthesis can be directly attached thereto. With those one-part implants the tooth abutment portion and the intraosseal anchor portion are made in one piece.

One-part implants usually suffer from the disadvantage in comparison with two-part implants that the orientation of the intraosseal anchor portion cannot be adjusted by means of a suitably angled tooth abutment portion, in such a way that the crown can be oriented so that an optimum appearance and an optimum bite pattern are achieved.

The object of the invention is to provide a dental implant which is suitable for implantation in the cosmetically relevant region and which avoids or at least reduces at least one and preferably a plurality of the above-mentioned problems.

In accordance with the invention that object is attained in that the intraosseal anchor portion is in the form of an intratissue anchor portion and the intratissue anchor portion and any tooth abutment portion is to be adapted to the individual gingival configuration by preparation by the dentist.

In that respect the reference to being in the form of a intratissue anchor portion denotes that the part of the dental implant which serves for intraosseal anchorage is also adapted to enjoy an additional anchorage effect in the region of the connective tissue, that is to say the gum. The intratissue anchor portion according to the invention therefore does not have to be sunk completely into the bone. In the case of the dental implant according to the invention therefore the intratissue anchor portion is adapted for integration in the bone and the connective tissue covering the bone (the gum). In this context the reference to connective tissue integration means that direct attachment of the connective tissue to the implant surface occurs above the bone.

The intratissue anchor portion of the dental implant according to the invention must further be of such a nature that it can be adapted to the individual anatomical situation by preparation by the dentist. In that way the intratissue anchor portion can be treated by the dentist for example in such a way that the region which protrudes from the tissue is concealed by the crown or the tooth abutment portion and thus account is also taken of the aesthetic requirements in the visible region. For that purpose on the one hand a choice of material in respect of the dental implant portions, which is suitable for treatment with the instruments provided, is required. Such adaptation is effected in particular by grinding or cutting away the intratissue anchor portion and the tooth abutment portion. Therefore the geometry is to be so selected that material-removing processing is possible. In that fashion the dental implant according to the invention allows and requires processing of the intratissue anchor portion and thus makes it possible to provide a dental prosthesis which is anatomically adapted and which satisfies the aesthetic demands.

The tooth abutment portion of the dental implant according to the invention can be in the form of a straight or angled abutment. The tooth abutment portion can have a cylindrical fixing face for the crown. Alternatively that fixing face can be conical, for example with a cone angle of 5 degrees. As an alternative thereto the tooth abutment portion can be provided with a ball knob structure for fixing a removable dental prosthesis.

It is in particular preferable for the intratissue anchor portion and the tooth abutment portion to be so designed that at least one external portion of the transition between the intratissue anchor portion and the tooth abutment portion is in an equi- and/or supragingival position in the implanted state.

That development of the dental implant according to the invention has the advantage that the microgap which is possibly formed comes to lie at least in part in a region which is not concealed by gum. The risk of irritants becoming caught in that microgap can be considerably reduced thereby as the microgap is usually concealed by the crown and, even if it is not concealed, it can be reached in the context of daily dental hygiene (with a toothbrush or the like). This involves only the outside region of the transition, that is to say the transition in the region of the outside face of the implant, as it is here that the microgap is opened towards the oral cavity and can thus serve as a germ reservoir.

In that respect the reference to equigingival position denotes an aligned arrangement of the portion of the microgap with the gingival boundary relative to the oral cavity. In that respect the reference to supragingival position denotes an arrangement of the portion of the microgap above the gingival boundary relative to the oral cavity, that is to say in the oral cavity.

Here the term implanted state denotes the immediately post-operative state. In many cases but not always the gum also regresses somewhat in the course of further healing (retraction) so that an initially equigingival position of the microgap can become supragingival in the healing process. The aim in accordance with the invention is to provide that in the definitive, fully healed and stable state, the microgap is equi- or somewhat supragingival, depending on the respective aesthetic demands involved.

It is particularly preferable if the intratissue anchor portion and the tooth abutment portion are of such a configuration that in the implanted state the lingual and/or buccal portion of the external transition between the intratissue anchor portion and the tooth abutment portion is in an equi- and/or supragingival position.

Often it is also advantageous if the intratissue anchor portion and the tooth abutment portion are of such a configuration that in the implanted state the portion of the external transition between the intratissue anchor portion and the tooth abutment portion, that faces towards the adjacent teeth, is in an equi- and/or supragingival position. Those two portions face towards the interdental space in which germs and irritants can often well accumulate and can be removed only with intensive dental hygiene with dental floss or the like. It is therefore advantageous if in the region of the interdental space any microgap which is possibly formed does not represent an additional nesting area for such germs, but rather that microgap is concealed by the crown or is easy to clean.

Finally it is advantageous if the intratissue anchor portion and the tooth abutment portion are of such a configuration that in the implanted state the entire external transition between the intratissue anchor portion and the tooth abutment portion is in an equi- and/or supragingival position. With that solution the entire microgap is concealed by the crown and the crown edge is readily accessible for daily care.

A further advantageous embodiment is distinguished by a crown edge receiving face which is provided on the intratissue anchor portion and/or on the tooth abutment portion and which is adapted to transmit the chewing forces applied to the crown onto the intratissue anchor portion or the tooth abutment portion respectively. That implant shoulder permits definitive positioning of the crown and allows for the chewing forces to be transmitted to the implant in a particularly advantageous fashion.

In that respect it is preferred if the crown edge receiving face is of an annular configuration along the periphery of the intratissue anchor portion and the tooth abutment portion respectively and faces towards the oral cavity in the axial direction. Such an annular configuration is particularly good for reworking and finishing by the dentist and allows a particularly advantageous wall thickness for the crown in the region of the transition to the tooth abutment portion and in the region of the crown edge receiving face.

Preferably the crown edge receiving face is at least partially or completely equi- or supragingival in the implanted state. With that design configuration the transitional gap between the crown and the implant can be disposed in a region which is preferred in respect of hygiene and this embodiment also permits the crown edge receiving face to be well worked by the dentist, including with a minimally invasive operating procedure.

The crown edge receiving face is preferably provided at the intratissue anchor portion and is at one height with the external transition between the intratissue anchor portion and the tooth abutment portion. That embodiment is particularly preferred as in that case both good working by the dentist is possible and also an advantageous arrangement of the microgap as well as good transmission of the chewing forces to the implant are afforded.

A further development is distinguished by a first anti-twist protection means for anti-twist fastening of the tooth abutment portion to the intratissue anchor portion and/or a second anti-twist protection means for anti-twist fastening of the crown to the tooth abutment portion. Considerable torsional forces act on tooth implants in a chewing operation, and those forces, besides the implant bed, also load the connecting regions of the implant itself. To carry those torsional forces it is advantageous if an anti-twist protection means of the above-described kind is provided, preferably by virtue of positively locking co-operation of the two implant portions which are prevented from twisting relative to each other.

A further aspect of the invention is a dental implant as described hereinbefore or as described in the opening part of this specification, in which the intratissue anchor portion and the tooth abutment portion are joined together by means of a shaft which extends in the longitudinal direction of the one portion and into which a pin provided on the other portion can be inserted. That fixing of the tooth abutment portion to the intratissue anchor portion in accordance with the invention permits a more liberal choice of material and thus allows a better aesthetic configuration for the dental prosthesis. Thus it is possible for example to use ceramic materials for both portions, or also plastic materials, coated materials, composite materials or material composites.

The pin can be of various cross-sections, for example rounded, or can be of a flattened angular elliptical shape, triangular or polygonal shapes, a star shape or a cloverleaf shape. Preferably but not necessarily the pin and the shaft are of geometrically identical cross-sectional shapes which however can be different from each other in their dimensions. In particular it is preferable if the pin and the shaft are of a quadrangular, in particular square cross-section so that the dentist using the prosthesis has the choice of joining the intratissue anchor portion and the tooth abutment portion to each other in two or four orientations relative to each other. That makes it possible for the dental implant according to the invention to be adapted to specific anatomical or operative factors.

In that respect the intratissue anchor portion and the tooth abutment portion can be joined together in particular by cemented anchoring of the pin in the shaft. In this context the term cementing is intended to denote that a projecting portion of the one part is introduced into a cavity in the other part, and in that case a gap which as far as possible is at all sides remains between the protruding portion and the cavity. Arranged in that gap is a cement which is applied prior to the parts being fitted together and which is applied in a liquid or pasty state and which after hardening preferably holds the two parts firmly together by the transmission of adhesive and cohesive forces. In particular it is also possible to provide that the two parts are held together by an increase in frictional force by means of the cement. Furthermore the cemented anchoring action enjoys the considerable advantage that the microgap is filled with cement.

Preferably the shaft, in a cross-sectional plane perpendicularly to its extent, can be of a cross-section which differs from a circular cross-section, preferably being an elliptical cross-section. That provides between the connected component parts a positively locking connection which affords an anti-twist protection means. In addition in that way it is possible for the orientation of the dental implant in the jawbone to be uniquely fixed and consequently it is possible to exclude the possibility of a mistake in the implantation procedure.

In particular in the cross-sectional plane the shaft can be of a larger dimension in a first direction which in the implanted state extends between the adjacent teeth on both sides of the implant, than in a second direction which is perpendicular to the first direction and which extends in a bucco-linqual direction. That dimensioning of the shaft is adapted in a particularly advantageous fashion to the usual external contour of the human teeth and on the one hand permits particularly advantageous anti-twist protection and on the other hand also permits an adequate thickness of material at any location of the dental implant in order to meet the stresses which occur in everyday loading situations.

Preferably the shaft is provided on the intratissue anchor portion and the pin on the tooth abutment portion. That permits good dimensioning of the wall thicknesses on the tooth abutment portion and in addition allows the intratissue anchor portion to be particularly well fitted into the jawbone by means of an instrument which is introduced into the shaft.

A further aspect of the invention is a dental implant as described hereinbefore or as described in the opening part of this specification, in which the intratissue anchor portion and optionally the tooth abutment portion comprises/comprise a ceramic material, in particular zirconium oxide. Ceramic materials and in particular zirconium oxide on the one hand have advantageous aesthetic properties as they are often in any case very similar in coloring to the natural tooth and can be matched to the natural teeth by slight modifications in respect of color. On the other hand the biocompatibility of ceramic materials is excellent and a biointegrative function and a bioinert function can be achieved by a choice from a large number of ceramic materials. In that respect ceramic materials, in particular zirconium oxide, offer excellent mechanical properties for that specific use as they have a high level of hardness and a high degree of strength in order to provide a long-lasting dental prosthesis. This embodiment can preferably be further developed in accordance with one or more features of one of the preceding advantageous embodiments.

A further aspect of the invention is a dental implant as described hereinbefore or as described in the opening part of this specification in which the tooth abutment portion comprises a first anchoring portion having a fastening means for fastening to the intraosseal anchor portion and a fastening face for fastening a modelable mass, and a second portion which can be produced by fastening, modeling and hardenable a modelable mass which is plastically deformable by the dentist or a dental technician, on the fastening face. That dental implant enjoys the advantage that the external contour of the tooth abutment portion, which projects into the oral cavity, can be easily individually modeled from a raw material, that is to say by plastic deformation, in particular by additive material application. The raw material can preferably be a composite.

In addition the object of the invention can be attained with a one-part dental implant of the kind set forth in the opening part of this specification, comprising a crown edge receiving face which is provided on the intratissue anchor portion and which is adapted to transmit the chewing forces applied to the crown to the tooth abutment portion or the intratissue anchor portion. In that case the crown edge receiving face is preferably of a design as already described hereinbefore.

In particular it is preferable if an anti-twist protection means is provided for anti-twist fastening of the crown to the intratissue anchor portion. That reliably prevents the crown from turning about the intratissue anchor portion.

The face for anchoring in the jawbone can preferably be provided with a macrostructure which promotes primary intraosseal anchoring, in particular with a screwthread or a plurality of raised portions. Such a structure can be provided by a single-flight or multi-flight screwthread which is geometrically designed in known manner for anchoring in bone material. In addition such a structure can be provided by raised portions. Furthermore it is possible to envisage a large number of other structures such as projections in the form of hooks or undercut configurations or the like.

Besides the macroscopic structure which promotes primary bone anchoring the face for bone anchoring can have a surface structure for promoting osseointegration. That can be produced for example by subtractive measures (sand blasting, etching and the like) or by additive measures (for example coatings).

Preferably a development of the dental implant as described hereinbefore or as described in the opening part of this specification comprises a connective tissue portion for attachment of gingival tissue, which is provided on the intratissue anchor portion and/or on the tooth abutment portion and which has a surface structure which promotes connective tissue integration. That connective tissue portion permits particularly efficient and stable attachment of connective tissue to the implant surface and thus facilitates saliva-tight wound closure after implantation and durable osseous and connective-tissue integration of the implant. The connective tissue portion can be produced by coating the base material or a modification of the base material such as for example etching or another removal process.

In that respect it is preferred if the connective tissue portion is not provided with the structure for promoting primary intraosseal anchoring.

It is particularly preferred for the connective tissue portion to have an approximately cylindrical or conical external face. The term approximately cylindrical is intended here to denote a cone angle of x/−8°, preferably +2°.

Furthermore the connective tissue portion can have a roughened surface structure. Thus the connective tissue portion can be provided with a surface roughness as can be achieved by glass bead blasting, glass powder blasting, etching or additive measures in order further to improve the soft tissue attachment effect.

A further aspect of the dental implant according to the invention lies in at least one rotation marking on the intratissue anchor portion and/or optionally on the tooth abutment portion, which rotation marking permits evaluation of the rotational alignment of the intratissue anchor portion or the tooth abutment portion respectively about the longitudinal axis of the implant during the implantation procedure. Such a rotation marking makes it possible for the laboratory technician and the dentist to clearly determine the implantation position of the implant in terms of rotation.

A further aspect of the invention involves providing at least one depth marking on the intratissue anchor portion, which depth marking makes it possible to evaluate the implantation depth of the intratissue anchor portion during the implantation procedure. Such a depth marking makes it possible for the implantation depth of the implant to be evaluated upon implantation and thus facilitates correct placement of the dental implant.

In that respect preferably a plurality of mutually spaced depth markings can be provided on the intratissue anchor portion, of which one depth marking is of a different nature from the other depth markings and that depth marking identifies the zero line of the implant. That development makes it possible for the implantation depth to be evaluated in more clearly differentiated fashion and to be accurately controlled.

In that respect the reference to the zero line of an implant denotes that line which is adjoined towards the implant tip by the region which is implanted in the bone. In that respect it is to be noted that the bone in the jaw region is generally of a wave-shape configuration, so that there is not a clear horizontally disposed bone boundary at the implant, but rather there is a bone boundary which extends in the manner of a garland. Accordingly below the zero line exclusively bone does not bear directly against the implant, but rather there is a mixed zone of connective tissue and bone at that location.

It is further advantageous to provide at least one height marking on the tooth abutment portion, which makes it possible to evaluate the abutment height of the tooth abutment portion. Such a height marking makes it possible to evaluate the height with which the tooth abutment portion projects into the oral cavity, during the treatment, and it thus facilitates correct adaptation of the tooth abutment portion outside the oral cavity.

The above-mentioned rotational, depth or height markings can be for example in the form of a small engraving, a color line, a color dot or another shaped portion or raised portion. In particular it is preferable for those markings to be applied by means of a laser, for example by laser engraving.

It is further preferred if the intratissue anchor portion and/or optionally the tooth abutment portion comprises/comprise a material, in particular zirconium oxide, which permits cutting and/or grinding processing with the instruments which are also used for the preparation of teeth in dental therapy. That development enjoys the advantage that processing with the usual instruments is possible in the dental prosthetic treatment. By virtue of that development, after implantation of the intratissue anchor portion and optionally fastening of the tooth abutment portion, further treatment, in particular grinding, shaping, crown fastening and post-working can be implemented in the same manner and with the same instruments as are used for the treatment of natural teeth. That has the advantage that each treating dentist can use his instruments with which he is familiar, with the treatment procedures with which he is familiar, in implantological treatment. In addition there is no longer any necessity for extensive training measures for the dentist and the dental technician as are required for conventional implant systems.

The development further leads to the crucial advantage that the dentist can easily perform post-working operations on the parts of the implant himself and consequently can achieve substantially better alignment and placement of the prosthetic care on the dental implant than when dealing with those implants which do not permit any further post-working after they have been manufactured in the laboratory. In that respect the capacity for working in dental therapy is not restricted to cutting/grinding with the dental instruments being basically possible at all, but rather that also involves the requirement that working with the dental instruments does not represent a stress or burden which is dangerous to the patient or the dentist performing the treatment, such as for example due to micro particles, liquids or gases which are involved in that respect, or due to physical effects such as the generation of heat or vibration.

In addition a further development of the dental implant according to the invention can provide that the intratissue anchor portion and/or optionally the tooth abutment portion comprises/comprise a material, in particular zirconium oxide, which permits cutting and/or grinding working with the instruments which are also used for processing dental prostheses in dental laboratories. Nowadays a large number of implant portions of different materials are processed in dental laboratories. In the course of saving on costs and achieving reductions in the possibility of mistakes occurring, it is desirable to reduce the instruments required for such processing. The dental implant according to the invention can therefore be developed by also using for that dental implant materials which are usually employed in conventional dental therapy. It is particularly advantageous according to the invention and is also only possible by virtue of the dental implant configuration according to the invention if all implant portions comprise a material which can be processed with the same instruments in order to avoid having to use a specific instrument for individual implant portions, which cannot be used for other implant portions. It is therefore particularly advantageous if the intratissue anchor portion and optionally the tooth abutment portion comprise the same material, at least a material which permits working processing with the same instruments.

The dental implant according to the invention is preferably implanted by means of a dental drill which includes a receiving portion for receiving the drill in a drilling tool and a drilling portion for cutting and/or grinding bone material, and in addition a first depth marking which is disposed on the receiving or drilling portion in such a way that the right drilling depth for a correct implant fit of an implant with a first implant length can be achieved by aligning the first depth marking with the surface of the bone, wherein there is provided a second depth marking which is disposed on the receiving or drilling portion in such a way that the right drilling depth for a correct implant fit of the implant of the first implant length can be achieved by aligning the second depth marking with the surface of the gum.

The drill according to the invention is distinguished in that it is particularly suitable for the minimally invasive operating procedure which is possible with the dental implant according to the invention as, besides positional identification by way of the bone by means of the first depth marking it also permits positional identification by way of the gum by way of the second marking. That means that operative representation of the bone is not required and it is nonetheless possible to produce a drilled hole of the correct depth.

In that respect it is particularly preferred if at least one further first depth marking and at least one further second depth marking are disposed on the receiving or drilling portion in such a way that the right drilling depth for a correct implant fit of an implant of a second implant length which is different from the first implant length can be achieved by aligning the first or the second depth marking with the surface of the bone or the surface of the gum. That provides that the drill according to the invention is also suitable for a plurality of different implant lengths.

It is further preferred if the first depth marking or markings is or are marked with a white color and the second depth marking or markings is or are marked with a red color. That coloring permits a direct association with the tissue in relation to which the position is to be established, as the coloring is the same as the color of the corresponding tissue.

A preferred embodiment of the dental implant according to the invention is described with reference to the Figures in which:

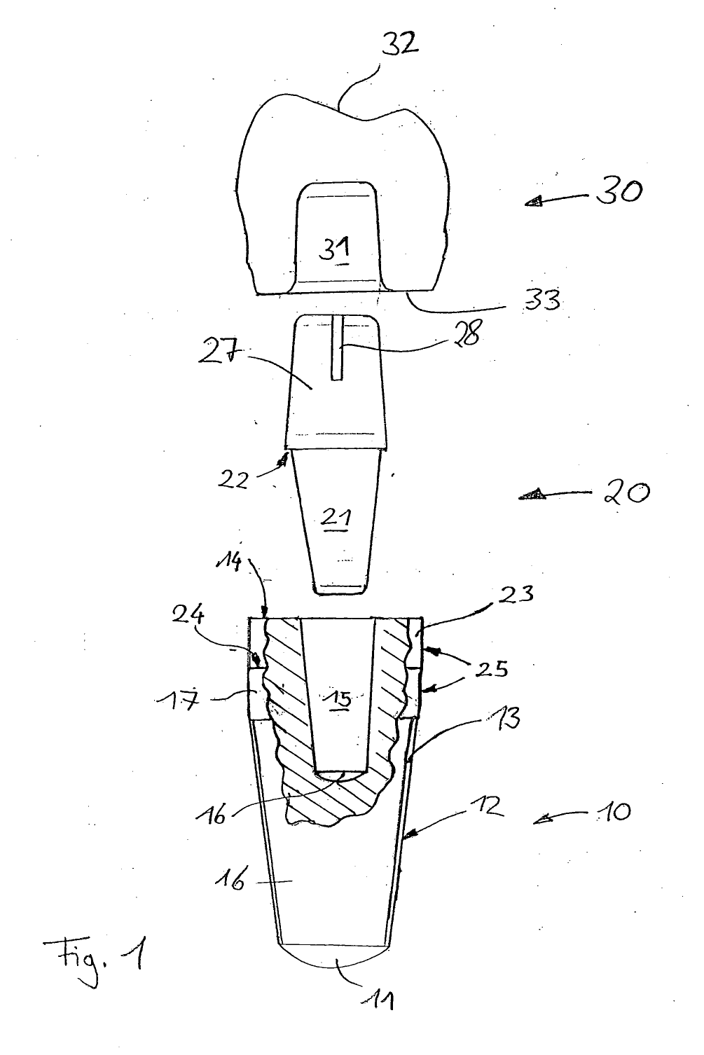

FIG. 1 shows an exploded view of a two-part dental implant according to the invention,

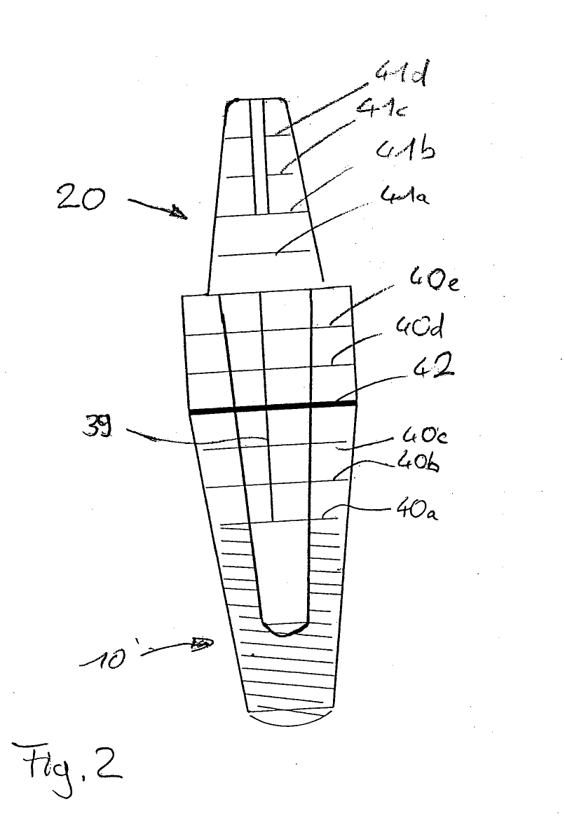

FIG. 2 shows a view of a two-part dental implant in the assembled condition,

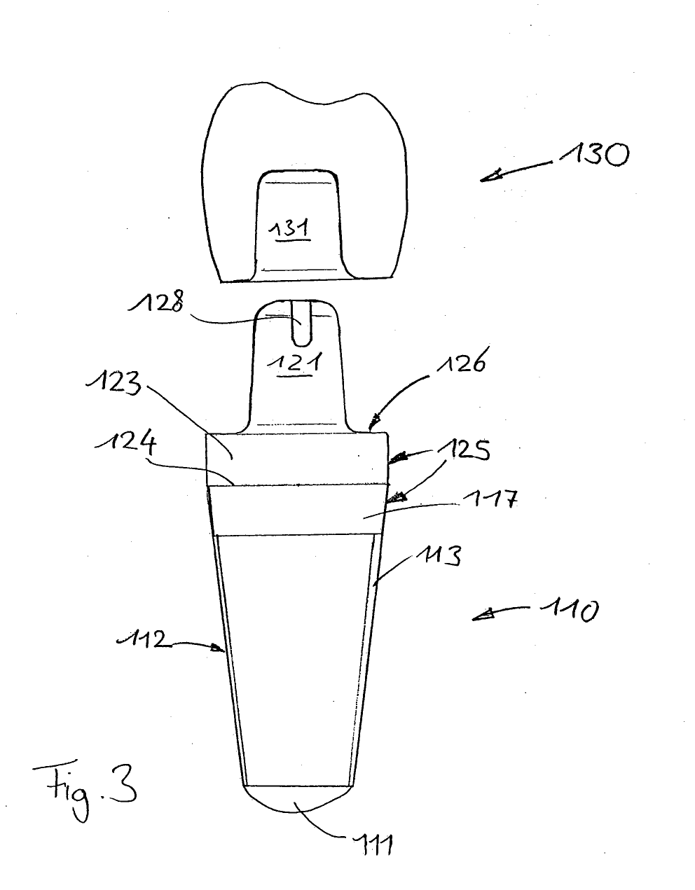

FIG. 3 shows an exploded view of a first embodiment of a one-part dental implant according to the invention,

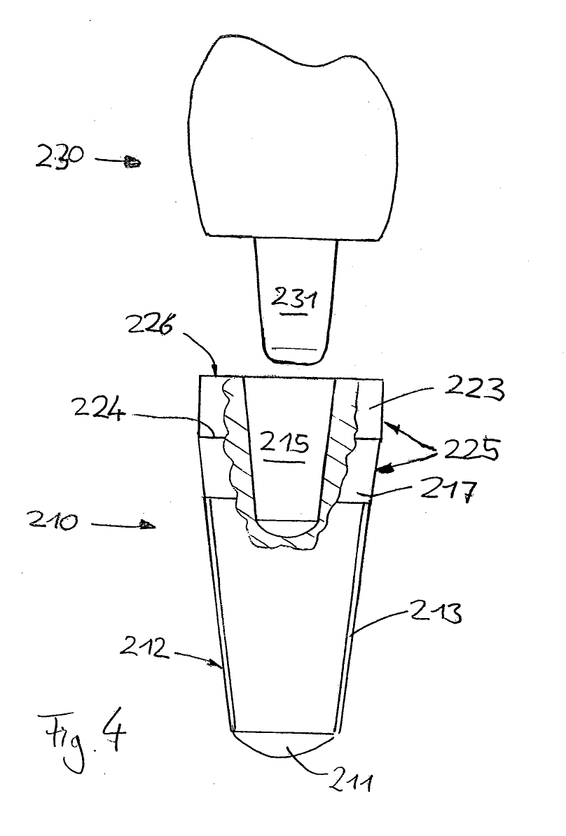

FIG. 4 shows an exploded view of a second embodiment of a one-part dental implant according to the invention,

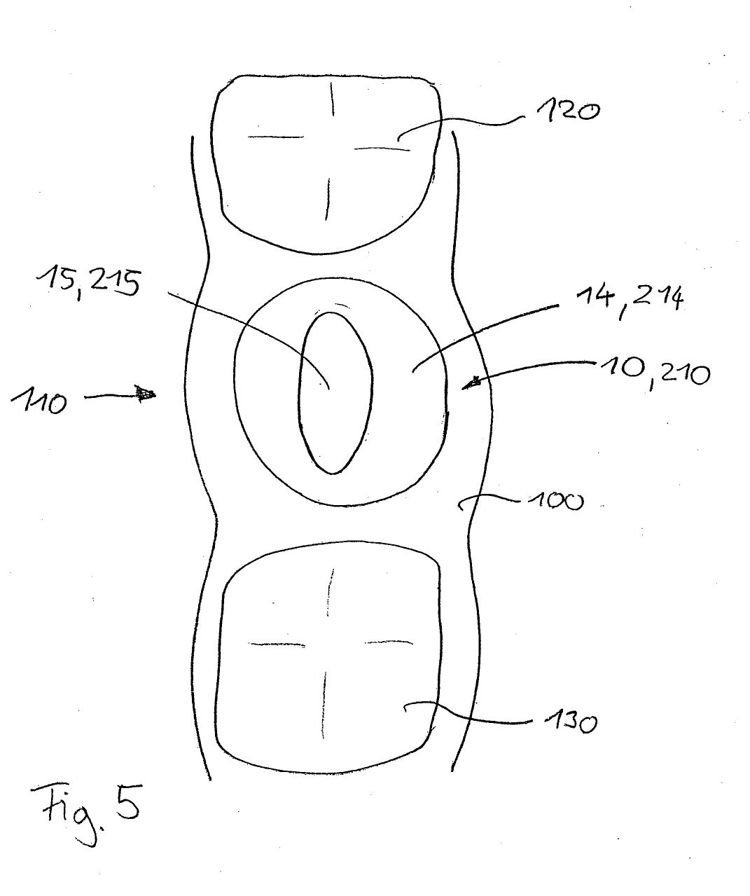

FIG. 5 shows a plan view of an intratissue anchor portion, anchored in a jawbone, of a dental implant according to the invention,

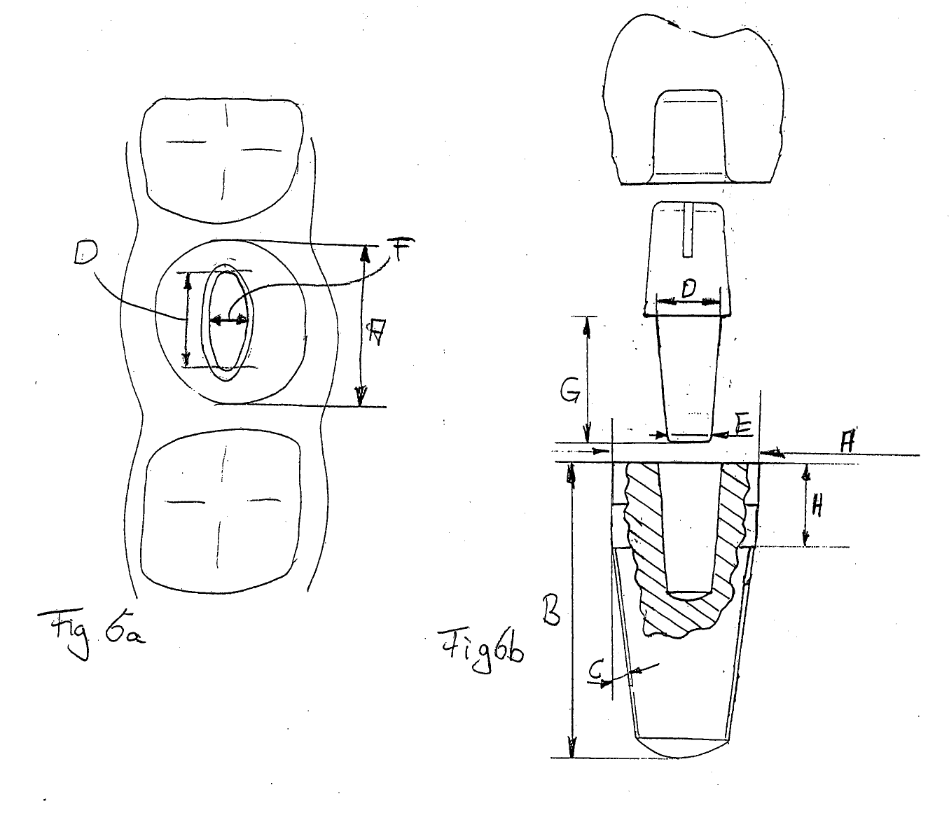

FIGS. 6a and 6b show a side view and a plan view of the dental implant according to the invention of typical characteristic dimensions, and

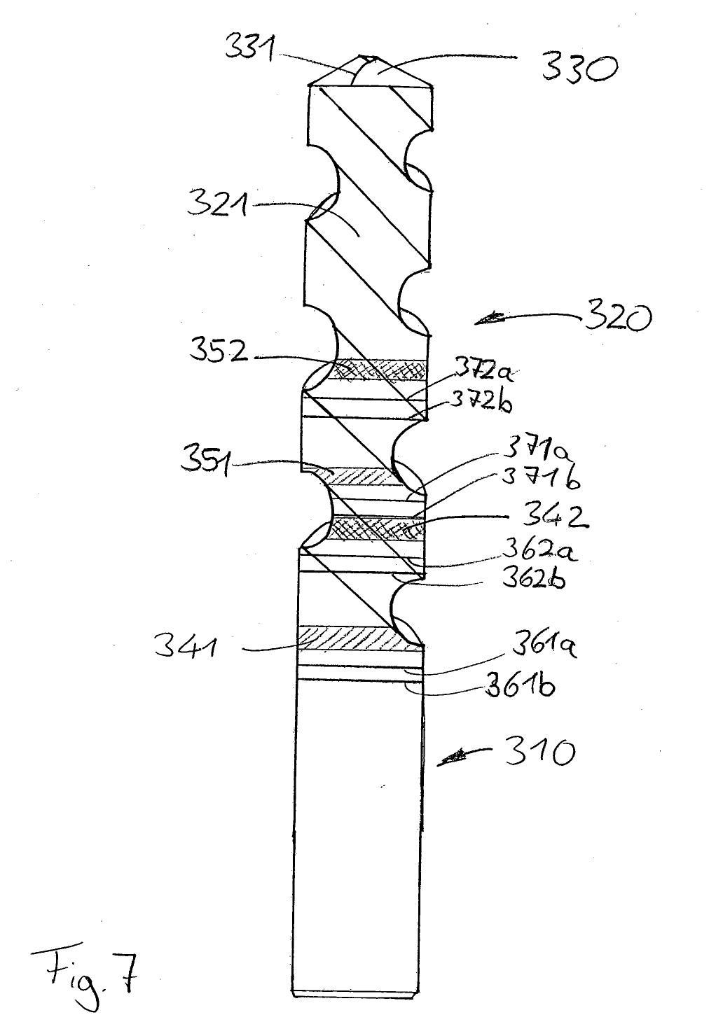

FIG. 7 shows a side view of a drill according to the invention.

FIG. 1 shows a dental implant comprising an intratissue anchor portion 10, a tooth abutment portion 20 and a crown 30. The dental implant is shown in an orientation for implantation in the lower jaw and reference is directed hereinafter to that orientation. Nonetheless it is to be appreciated that the dental implant could equally be fitted into the upper jaw in the inverted position, that is to say in mirror image relationship about a horizontal axis.

The intratissue anchor portion 10 has a lower rounded tip 11 which comes to lie in the depth of the jawbone and which is adjoined by an upwardly conically enlarging cylindrical external face 12.

In the lower region the external face 12 is provided with a male screwthread 13 which typically involves a screwthread depth of about 0.3 mm. In the upper portion the intratissue anchor portion has a region 17 which also enlarges conically upwardly and which is in the form of a mixed tissue attachment region 25 and which serves as an attachment zone for a mixed tissue of bone and connective tissue.

Upwardly adjoining the upwardly conically enlarging region 17 is a cylindrical portion 23 which is of a cylindrical shape of constant diameter and the external face of which is also in the form of a connective tissue attachment region 25 serving as an attachment zone for connective tissue. A zero line 24 is disposed between the upwardly conically enlarging region 17 and the cylindrical portion 23.

In the upper region the intratissue anchor portion terminates with a flat end face 14. Arranged in the flat end face 14 is a pin shaft 15 extending from the end face 14 in the direction of the rounded tip 11. The pin shaft 15 is once again of a downwardly conically converging configuration in the view in partial longitudinal section shown in FIG. 1, and terminates in the lower region with a rounded pin shaft tip 16.

A conically converging pin 21 of the tooth abutment portion 20 can be introduced into the pin shaft 15. The pin 21 extends downwardly from an annular end face 22 which faces in the direction of the intratissue anchor portion and, when the end face 22 is applied against the end face 14 of the intraosseal anchor portion, between the external surface of the pin 21 and the internal surface of the pin shaft 15 there is a gap in which a cement material (not shown) is disposed.

The pin 21 is adjoined by an upwardly conically converging projection portion 27. The projection portion 27 has a longitudinal gap 28 or two longitudinal gaps which are disposed perpendicularly to each other, serving as a rotation-preventing means and rotation marking between the tooth abutment portion 20 and the crown 30.

A crown 30 can be fitted onto the conically converging projection portion 27 by a corresponding conical recess 31 in the crown being guided over the projection portion 27. The connection between the tooth abutment portion 20 and the crown 30 can be made in a similar manner to the connection of the pin 21 in the pin shaft 15, by means of cementing.

The crown 30 is shaped in respect of its external contour 32 in accordance with the individual, anatomical requirements of the bite of the patient. In the final state, the lower crown edge face 33 bears against the end face 14 of the intratissue anchor portion 10.

Referring now to FIG. 2, shown therein in the assembled condition is an intratissue anchor portion 10 with a tooth abutment portion 20 fastened thereto. FIG. 2 further shows a rotation marking 39, depth markings 40a-e, height markings 41a-d and a differentiated marking 42 in respect of the zero line 34. A further rotation marking (not shown) is arranged in displaced relationship through 180° opposite to the rotation marking 39.

FIG. 3 shows a further embodiment of the dental implant according to the invention. The illustrated embodiment includes a one-part intratissue anchor portion 110 having a rounded tip 111 and a male screwthread 113, which are of the same structure as the above-described rounded tip 11 and the male screwthread 13.

Adjoining the intratissue anchor portion in one piece is a conical face portion 117 which extends from the screwthread 113 to a zero line 124 and whose external face serves as a mixed tissue attachment zone 125 for attachment of a mixed tissue comprising bone and connective tissue.

Above the zero line 124 the intratissue anchor portion 110 has a cylindrical region 123 which extends as far as an annular axial end face 126 and whose external face also serves as a mixed tissue attachment zone 125 for attachment of the connective tissue.

Provided at the end face 126 is a projection 121 which extends from the end face 126 in the longitudinal direction of the implant.

The one-part dental implant shown in FIG. 3 further includes a crown 130 with a recess 131 which is formed therein and which is geometrically congruent with the projection 121 and which is adapted to the projection 121 for cementing fastening of the crown 130. In this case also adaptation of the crown is required by a dentist or a dental technician, as described with reference to FIG. 1.

FIG. 4 shows a further embodiment of the dental implant according to the invention. The illustrated embodiment includes a one-part intratissue anchor portion 210 having a rounded tip 211 and an external face 212 with a male screwthread 213, which are constructed in the same manner as the above-described rounded tip 11 and the male screwthread 13.

Adjoining the intratissue anchor portion in one piece is a conical face portion 217 which extends from the screwthread 213 to a zero line 224 and serves as a mixed tissue attachment zone 225 for a mixed tissue comprising bone and connective tissue.

Above the zero line 224 the intratissue anchor portion 210 has a cylindrical region 223 which extends as far as an annular, axial end face 226 and whose external face serves as a connective tissue attachment zone for the connective tissue.

Formed in the end face 226 is a pin shaft 215 which extends from the end face 226 in the direction of the rounded tip 211 and which is formed in the same manner as the above-described pin shaft 15.

The one-part dental implant shown in FIG. 4 further includes a crown 230 with a pin 231 which is formed thereon in one piece and which is geometrically congruent with the pin shaft 215 and which is adapted for cemented fastening of the crown 230 in the pin shaft 215. In this case also adaptation of the crown is required by the dentist or dental technician, as described with reference to FIG. 1.

FIG. 5 shows a part of a jawbone 100 with an interdental gap 110 and teeth 120, 130 arranged adjacent to the gap 110. An intratissue anchor portion 10 is anchored in the interdental gap 110 and the plan view shows the annular, axial end face 14. A pin shaft 15 of oval cross-section is formed in the end face 14. The longer of the two oval axes extends in the direction of the two adjacent teeth 120, 130 while the shorter of the two axes of the ellipse is oriented in perpendicular relationship therewith and extends from the oral cavity side towards the cheek side.

The implant according to the invention is preferably provided in various size dimensions in order that it can be adapted to the respective different anatomical conditions in terms of dental prosthesis in respect of incisors, canines or molars and can be appropriately selected and on the other hand so that it can be selected in such a way as to be adapted to the different anatomical conditions in dependence on the respective size of the jawbone of the patient. The Table hereinafter shows with reference to FIGS. 6a and 6b preferred dimensions of the implant for different sizes of the implant series.

| | | taper angle | | | | | length |
|---|---|---|---|---|---|---|---|
| implant | | beneath | | pin width | pin | | of the |
| diameter | implant | the zero | pin width | at bottom | thickness | pin length | thread-free |
| A | length B | line C | at top D | E | F | G | portion H |
| 3.5 | 11, 13, | 2 | 2 | 1.2 | 1.2 | 9 | 6 |
| | 15, 17 | | | | | | |
| 4 | 11, 13, | 3 | 2 | 1.2 | 1.2 | 9 | 6 |
| | 15, 17 | | | | | | |
| 5 | 11, 13, | 5 | 3 | 1.8 | 1.8 | 9 | 6 |
| | 15, 17 | | | | | | |
| 6 | 11, 13, | 5 | 3 | 1.8 | 1.8 | 9 | 6 |
| | 15, 17 | | | | | | |
| 7 | 11, 13, | 5 | 3 | 1.8 | 1.8 | 9 | 6 |
| | 15, 17 | | | | | | |

FIG. 7 shows a bone drill comprising a receiving portion 310 for fastening the drill bit in a drilling tool, a drilling portion 320 with chip discharge passages 321 and a drill tip 330 with cutting edges 331.

In the region of the receiving portion and the drilling portion the drill has a red marking 341 for a first implant length and a white marking 342 for the same implant length.

The correct drilling depth can be set by means of the marking 341, by drilling being effected to such a depth that the red marking 341 is aligned with the surface of the gum.

The correct drilling depth can be set by means of the marking 342, by drilling being effected to such a depth that the white marking 342 is aligned with the surface of the bone.

In addition the drill has a further red marking 351 and a further white marking 352 with which the correct drilling depth for a second, shorter implant length can be set in a similar fashion.

Finally the drill also has further black markings 361a, b, 362a, b, 371a, b and 372a, b, of which each two are associated with respective white and red marking. Those markings make it possible for the drilled hole to be deliberately set a short distance deeper than is provided by the white and red markings in order in that way to avoid the danger of an excessively short drilled hole.

1. Dental implant comprising
an intraosseal anchor portion (10) anchorable in the jawbone with an external face (13), for anchoring in the jawbone,
a tooth abutment portion (20) fastenable to said intraosseal anchor portion, a crown (30) being attachable to said tooth abutment portion,
characterized in that the intraosseal anchor portion is configured as an intratissue anchor portion and the intratissue anchor portion and any tooth abutment portion is adapted to the individual gingival contours through preparation by the dentist.

2. Dental implant according to claim 1,
characterized in that the intratissue anchor portion and the tooth abutment portion are configured in a such a way that in the implanted state at least one external portion of the transition (14, 22) between the intratissue anchor portion and the tooth abutment portion is in an equi- and/or supragingival position.

3. Dental implant according to claim 1,
characterized in that the intratissue anchor portion and the tooth abutment portion are configured in such a way that in the implanted state the lingual and/or buccal portion of the external transition (14, 22) between the intratissue anchor portion and the tooth abutment portion is in an equi- and/or supragingival position.

4. Dental implant according to one of the preceding claims, claim 1
characterized in that the intratissue anchor portion and the tooth abutment portion are configured in such a way that in the implanted state the portion of the external transition (14, 22) between intratissue anchor portion and tooth abutment portion which faces the adjacent teeth is in an equi- and/or supragingival position.

5. Dental implant according to claim 1,
characterized in that the intratissue anchor portion and the tooth abutment portion are configured in a such a way that in the implanted state the entire external portion of the transition (14, 22) between the intratissue anchor portion and the tooth abutment portion is in an equi- and/or supragingival position.

6. Dental implant according to claims, claim 1
characterized by a crown edge receiving face (14) defined on the tooth abutment portion and/or on the intratissue anchor portion, said crown edge receiving face being configured to transmit the chewing forces absorbed by the crown (30) onto the tooth abutment portion and the intratissue anchor portion.

7. Dental implant according to claim 6,
characterized in that the crown edge receiving face (14) is annular in shape along the periphery of the tooth abutment portion and the intratissue anchor portion and faces the oral cavity in the axial direction.

8. Dental implant according to claim 6,
characterized in that in the implanted state the crown edge receiving face (14) is at least partially and preferably entirely in an equi- and/or supragingival position.

9. Dental implant according to claim 6
characterized in that the crown edge receiving face (14) is defined on the intratissue anchor portion and is at an equal height with the external transition (14, 22) between the intratissue anchor portion and the tooth abutment portion.

10. Dental implant according to claim 6,
characterized by a first anti-twist protection means for anti-twist fastening of the tooth abutment portion to the intratissue anchor portion and preferably at least one second anti-twist protection means (28) for anti-twist fastening of the crown to the tooth abutment portion.

11. Dental implant according to claim 1,
characterized in that the intraosseal anchor portion and the tooth abutment portion (20) can be joined to each other by means of a shaft (15) extending in the axial direction of the one portion, into which shaft a pin (21) defined on the other portion can be inserted.

12. Dental implant according to claim 11,
characterized in that the intratissue anchor portion and the tooth abutment portion can be joined to each other by cemented anchoring of the pin (21) inside the shaft (15).

13. Dental implant according to claim 11,
characterized in that in a cross-sectional plane perpendicular to its extension the shaft (15) has a cross-section, preferably an ellipsoidal cross-section, that deviates from a circular cross-section.

14. Dental implant according to claim 13,
characterized in that, in the cross-sectional plane, the shaft (15) has larger dimensions in a first direction extending in the implanted state between the adjacent teeth on either side of the implant than in a second direction perpendicular to the first and extending in a buccolingual direction.

15. Dental implant according to claim 11,
characterized in that the shaft is provided on the intratissue anchor portion and the pin is defined on the tooth abutment portion.

16. Dental implant according to claim 11,
characterized by a crown edge receiving face.

17. Dental implant according to claim 1,
characterized in that the intraosseal anchor portion (10; 110; 210) and where relevant the tooth abutment portion (20; 120; 220) consist of a ceramic material, in particular of zirconium oxide.

18. Dental implant according to claim 17,
characterized in that the intratissue anchor portion and the tooth abutment portion are configured in a such a way that in the implanted state at least one external portion of the transition (14, 22) between the intratissue anchor portion and the tooth abutment portion is in an equi- and/or supragingival position.

19. Dental implant according to claim 1,
characterized in that the tooth abutment portion comprises
a first anchoring portion having
a fastening means for fastening said anchoring portion to the intraosseal anchor portion and having
a seating for fastening a modelling mass, and
a second portion that can be made by fastening, modelling and hardening to the seating a mass that can be plastically deformed and modelled by a dentist or dental technician.

20. Dental implant according to claim 19,
characterized in that the intraosseal anchor portion and the tooth abutment portion (20) can be joined to each other by means of a shaft (15) extending in the axial direction of the one portion, into which shaft a pin (21) defined on the other portion can be inserted.

21. Dental implant comprising
an intratissue anchor portion (110; 210) anchorable in the jawbone with an external face (113; 213) for anchoring in the jawbone and a second face for fastening a crown,
characterized by a crown edge receiving face (126; 226) defined on the intratissue anchor portion, said crown edge receiving face being configured to transmit the chewing forces absorbed by the crown onto the intratissue anchor portion.

22. Dental implant according to claim 21,
characterized in that the crown edge receiving face (14) is annular in shape along the periphery of the tooth abutment portion and the intratissue anchor portion and faces the oral cavity in the axial direction.

23. Dental implant according to claim 21,
characterized in that the external face (12; 112; 212) for anchoring in the jawbone is provided with a structure (13; 113; 213) fostering intraosseal anchoring and/or osseointegration, in particular with a thread or a plurality of raised portions.

24. Dental implant according to claim 1,
characterized in that a binding tissue portion (25; 125; 225) formed for attachment of gingival tissue is provided on the intratissue anchor portion and/or on the tooth abutment portion, said binding tissue portion having a surface structure that makes possible and/or fosters the integration of binding tissue.

25. Dental implant according to claim 24,
characterized in that the binding tissue portion is not provided with a macrostructure which promotes primary intraosseal anchoring.

26. Dental implant according to claim 24,
characterized in that the binding tissue portion has an external face that is approximately cylindrical or tapers conically towards the oral cavity.

27. Dental implant according to claim 24,
characterized in that the binding tissue portion has a roughened surface structure.

28. Dental implant according to claim 21,
characterized by at least one rotation marking (39, 28) on the intratissue anchor portion and/or, where relevant, on the tooth abutment portion, said rotation marking enabling the rotational alignment of the intratissue anchor portion and/or the tooth abutment portion about the longitudinal axis of the implant to be evaluated during implantation and treatment.

29. Dental implant according to claim 21,
characterized by at least one depth marking (24, 124, 224) on the intratissue anchor portion and/or, where relevant, on the tooth abutment portion, said depth marking enabling the implantation depth of the intratissue anchor portion to be evaluated during implantation.

30. Dental implant according to claim 29,
characterized by a plurality of spaced apart depth markings (40a-e, 42) on the intratissue anchor portion and/or, where relevant, on the tooth abutment portion, of which one depth marking (42) is different in form to the other depth markings (40a-e) and said depth marking indicating the zero line of the implant.

31. Dental implant according to claim 29,
characterized by at least one height marking (41a-d) on the tooth abutment portion, said height marking allowing the abutment height of the tooth abutment portion to be evaluated.

32. Dental implant according to claim 21,
characterized in that the intratissue anchor portion and/or, where relevant, the tooth abutment portion consist(s) of a material, in particular of zirconium oxide, that permits cutting and/or grinding with the instruments that are also used in dental therapy to prepare teeth.

33. Dental implant according to claim 32,
characterized in that the intratissue anchor portion and/or, where relevant, the tooth abutment portion consist(s) of a material, in particular of zirconium oxide, that permits cutting and/or grinding with the instruments that are also used in dental therapy to process replacement teeth.

34. Dental drill comprising
a receiving portion for receiving the drill bit in a drilling tool and
a drilling portion for cutting and/or grinding bone material,
further comprising a first depth marking (352) disposed on the receiving or drilling portion such that the right drilling depth for a correct implant seat of an implant with a first implant length can be achieved by aligning the first depth marking with the surface of the bone,
further comprising a second depth marking (351) disposed on the receiving or drilling portion such that the right drilling depth for a correct implant seat of an implant with a first implant length can be achieved by aligning the second depth marking with the surface of the gum.

35. Drill according to claim 34,
characterized by at least one additional first (342) and at least one additional second depth marking (341) disposed on the receiving or drilling portion such that the right drilling depth for a correct implant seat of an implant with a second implant length different to the first implant length can be achieved by aligning the first or the second depth marking with the surface of the bone or the gum.

36. Drill according to claim 34,
characterized in that the first depth marking(s) (352, 342) is/are marked with a white colour and the second depth marking(s) (351, 341) is/are marked with a red colour.

37. Drill according to claim 36,
characterized in that at least one third marking (372a,b, 371a,b) is disposed spaced apart from the first depth marking(s) and second depth marking(s), said third marking permitting a bearing for a bore depth increment for the respective implant length by aligning the third depth marking with the surface of the bone and/or the surface of the gum.
